(19) United States
(12) Patent Application Publication
(10) Pub. No.: US 2025/0005098 A1
(43) Pub. Date: Jan. 2, 2025

(54) PLAN VISUALIZATION BY DISAMBIGUATION

(71) Applicant: INTERNATIONAL BUSINESS MACHINES CORPORATION, Armonk, NY (US)

(72) Inventors: Jung Koo KANG, Wakefield, MA (US); Michael KATZ, Goldens Bridge, NY (US); Tathagata CHAKRABORTI, Cambridge, MA (US); Shirin SOHRABI ARAGHI, Briarcliff Manor, NY (US)

(21) Appl. No.: 18/342,823

(22) Filed: Jun. 28, 2023

(51) Int. Cl. G06F 17/11

(52) U.S. Cl. CPC G06F 17/11

(57) ABSTRACT

Computer implemented methods, systems, and computer program products include program code executing on a processor(s) that identifies a planning problem and obtains a set of plans for the planning problem. The program code determines a set of disambiguation criteria for the plans (in the set of plans). The program code iteratively reduces the plans until a termination event occurs. The program code determines that the set of plans comprises more than one plan, selects a disambiguation criterion from the disambiguation criteria, determines which plans on the set of plans comprise the disambiguation criterion, generates and displays a graphical representation of the plans comprising the disambiguation criterion and a prompt to select an option of the two of more options of the disambiguation criterion set. The program code obtains a selection from the user and reduces the plans to those comprising the selection.

### BACKGROUND

The present invention relates generally to the field of artificial intelligence (AI) in computing and specifically, reducing central processing unit (CPU) time to process instructions that problem solving in top-quality planning.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Automated planning and scheduling, referred to as AI planning is a branch of AI that concerns the realization of strategies or action sequences, typically for execution by intelligent agents, autonomous robots, and/or unmanned vehicles. Because solutions in AI planning are more complex than classical control and classification problems, AI planning problems are generally discovered and optimized in multidimensional space. AI planning, also referred to as automated planning, aims to solve problems, modeled in an input language, wherein solving the problems involves finding a strategy of action provided they are modeled in a suitable input language. Optimal planning in AI planning refers to finding a best solution to a problem. A planning problem in AI refers to a problem with some initial starting state, which one wishes to transform into a desired goal state through the application of a set of actions.

### SUMMARY

Shortcomings of the prior art are overcome, and additional advantages are provided through the provision of a computer-implemented method for utilizing disambiguation to identify a preferred plan from a set of plans for a planning problem. The computer-implemented method can include: identifying, by one or more processors, a planning problem, wherein the planning problem comprises an initial state and a goal state; obtaining, by the one or more processors, plans comprising the set of plans for the planning problem; determining, by the one or more processors, a set of disambiguation criteria for the plans comprising the set of plans; iteratively reducing, by the one or more processors, the plans comprising the set of plans until a termination event occurs, the iteratively reducing comprising: determining, by the one or more processors that the set of plans comprises more than one plan; based on the determining, selecting, by the one or more processors, a disambiguation criterion from the disambiguation criteria, wherein the disambiguation criterion comprises a set of two or more options; identifying, by the one or more processors, plans of the set of plans that comprise the disambiguation criterion; generating and displaying, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set; obtaining, by the one or more processors, a selection from the user; and based on the selection, reducing, by the one or more processors, the set of plans from the set of plans comprising the disambiguation criterion to the set of plans comprising the selection.

Shortcomings of the prior art are overcome, and additional advantages are provided through the provision of a computer program product for utilizing disambiguation to identify a preferred plan from a set of plans for a planning problem. The computer program product comprises a storage medium readable by one or more processors and storing instructions for execution by the one or more processors for performing a method. The method includes, for instance: identifying, by the one or more processors, a planning problem, wherein the planning problem comprises an initial state and a goal state; obtaining, by the one or more processors, plans comprising the set of plans for the planning problem; determining, by the one or more processors, a set of disambiguation criteria for the plans comprising the set of plans; iteratively reducing, by the one or more processors, the plans comprising the set of plans until a termination event occurs, the iteratively reducing comprising: determining, by the one or more processors that the set of plans comprises more than one plan; based on the determining, selecting, by the one or more processors, a disambiguation criterion from the disambiguation criteria, wherein the disambiguation criterion comprises a set of two or more options; identifying, by the one or more processors, plans of the set of plans that comprise the disambiguation criterion; generating and displaying, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set; obtaining, by the one or more processors, a selection from the user; and based on the selection, reducing, by the one or more processors, the set of plans from the set of plans comprising the disambiguation criterion to the set of plans comprising the selection.

Shortcomings of the prior art are overcome, and additional advantages are provided through the provision of a system for utilizing disambiguation to identify a preferred plan from a set of plans for a planning problem. The system includes: a memory, one or more processors in communication with the memory, and program instructions executable by the one or more processors via the memory to perform a method. The method includes, for instance: identifying, by the one or more processors, a planning problem, wherein the planning problem comprises an initial state and a goal state; obtaining, by the one or more processors, plans comprising the set of plans for the planning problem; determining, by the one or more processors, a set of disambiguation criteria for the plans comprising the set of plans; iteratively reducing, by the one or more processors, the plans comprising the set of plans until a termination event occurs, the iteratively reducing comprising: determining, by the one or more processors that the set of plans comprises more than one plan; based on the determining, selecting, by the one or more processors, a disambiguation criterion from the disambiguation criteria, wherein the disambiguation criterion comprises a set of two or more options; identifying, by the one or more processors, plans of the set of plans that comprise the disambiguation criterion; generating and displaying, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set; obtaining, by the one or more processors, a selection from the user; and based on the selection, reducing, by the one or more processors, the set of plans from the set of plans comprising the disambiguation criterion to the set of plans comprising the selection.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a workflow that provides an overview of various aspects performed by the program code (executing on one or more processors) in some embodiments of the present invention;

FIG. 3 is visualization generated by the program code in some examples herein;

FIG. 4 is visualization generated by the program code in some examples herein;

FIG. 5 is a workflow that provides an overview of various aspects performed by the program code (executing on one or more processors) in some embodiments of the present invention; and

FIG. 6 is a system diagram that illustrates various aspects of some examples herein.

### DETAILED DESCRIPTION

Automated planning or AI planning is a sub-area of AI that includes solving problems where the solution involves finding a strategy of action. Program code, executed by at least one processor, solves these problems, in part, by the program code modeling the problems in an effective input language. This automated planning includes finding one best solution to a problem. Although various optimal planners exist and can be used to solve certain very specific types of problems, when dealing with diverse problems of a high complexity, including PSPACE-hard problems, there is no present approach that can handle the breadth of problems of this complexity. PSPACE (polynomial space) refers to a set of all decision problems that can be solved by a Turing machine using a polynomial amount of space. A problem considered PSPACE-hard if an algorithm that solves the problem can be transformed into an algorithm that solves any other problem in PSPACE in a polynomial amount of time. The term PSPACE-hard is used to designate a complexity class in theoretical computer science that captures the set of decision problems that can be solved by a deterministic Turing machine using a polynomial amount of memory space in which the problems are unlikely to have efficient solutions.

An example of a type of problem that various AI planning approaches can be used to attempt to solve is unordered top-quality planning. This problem can be articulated as given q, the program code tries to find all plans of cost up to q times optimal. In solving this problem, the program code may skip re-orderings of the plans. Re-orderings can be skipped because, from an application perspective, often two valid plans that are re-orderings of each other are equivalent. Thus, if the program code were to provide both, it would be providing duplicative information and would waste processing time and resources in generating and providing both plans. Existing AI planning approaches to solving unordered top-planning problems include, but are not limited to, a symbolic search based approach (i.e., program code provides top-quality plans and checks duplicates based on unordered variants), a forbid iterative based approach (i.e., program code utilizes cost-optimal planners to find a single plan and iteratively reformulates a planning problem to reduce a space of plans), and a K* search based approach (i.e., program code utilizes a two-phase search to iteratively develop a search space and attempts to extract top-quality solutions, which includes the program code finding all top-quality plans and checking duplicates based on unordered variants).

A challenge in AI planning when finding all top-quality plans is the program code determining which of the plans is the best plan. Aspects that can impact which plan of a set generated by the program code is best include constraints and preferences. However, constraints and preferences are not always known upfront. Thus, a first plan returned by the program code could conceivably not be the best plan based on one or more constraints that were unknown when the program code generated the plans. To return the “best” plan in the absence of certain information that could have been used to determine that a plan is the best plan, various AI planning approaches return a set of solutions (e.g., a set of plans). However, when obtaining the set of plans, many existing AI planning approaches lack the functionality to determine which plan is the best plan. Some existing approaches utilize somewhat random processes to guess which plan would be the best plan. These approaches include selecting (and executing) a first options returned (assuming this is the optimal plan based on constraints utilized when the program code generates the plans) and ignoring the remaining options (plans), selecting a plan at random to resolve this ambiguity, and selecting a plan while ignoring (unmodeled) user preferences. Thus, present approaches do not disambiguate among a set of plans based on user preferences which can create constraints which affect which plan would be best for addressing the AI planning problem. The examples herein provide a significant improvement over these existing approaches because in these examples, the program code can disambiguate among a set of plans by utilizing formerly unknown user-driven constraints and preferences through a communication with the user and/or utilizing machine learning to learn and apply these constraints and preferences.

Embodiments of the present invention include computer-implemented methods, computer program products, and computer systems that enable program code executing one or more processors to select a preferred plan (among plans generated by the program code to address an AI planning problem) by utilizing disambiguation. The program code in some examples specifically presents solutions to a user in a manner that enables the user to understand which plan would be the preferred plan via this disambiguation. As discussed in more detail below, program code executing on one or more processors in these examples provides significant improvements over existing approaches to plan differentiation including, but are not limited to: 1) assisting users in selecting a preferred plan (e.g., from a set of plans) via disambiguation; 2) generating and proactively pose questions that enable reduction of the set of relevant plans (returned by an AI planning algorithm applied by the program code); 3) visualizing the plans to facilitate disambiguation. Regarding the first significant improvement, the program code can automatically compute and utilize disjunctive action landmarks (automatically computed) to generate the questions provided to the user. Regarding the third significant improvement, by visualizing the plans, the program code enables users to build up from nothing or select down from a set of plans using disambiguation options.

Disambiguation generally refers to the act of interpreting an author's intended use of a word that has multiple meanings or spellings. In the computing context, ambiguity is when something is open for more than one interpretation. Disambiguation eliminates this ambiguity by interpreting the intent and/or contextualizing the object of this ambiguity. In order to remove ambiguity, program code can interact with a user and determine, based on this interaction, generally, an accurate response, but in the context of AI planning, a preferred plan. The concept of disambiguation can be understood by illustrating how humans disambiguate and detect subtle nuances. In this example, two sentence fragments are provided: a) “A drop of water on my mobile phone;” and b) “I drop my mobile phone in the water.” These two sentences have vastly different meanings, and compared to each other there is no real ambiguity, but without the understood context (which is inherently understood in this example by a human) the differences would be hard to detect and separate.

In the examples herein, the program code enables a user to understand which plan would be a preferred plan via the program code performing disambiguation. In some examples, the program code will proactively pose questions to a user, via an interface, and based on the answers, the program code can reduce the set of relevant plans returned by the program code applying an AI planning algorithm to one or more preferred plans. In formulating these questions, the program code can utilize disjunctive action landmarks, which the program code can compute automatically, to ask the (e.g., most important) questions. In AI planning, a landmark is an object (e.g., thing, action, etc.) that holds for every plan (solving a given planning problem). Action landmarks are actions that are required in a plan that solves a planning problem; you skip the action landmark in a plan, you do not reach the goal of the planning problem. For example, if there are only two solutions to achieve the goal A->B->D, A->C->D then A is there as an action landmark. Disjunctive action landmarks are a set of landmarks one of which are required in all the solutions; every plan generated by the program code applying the AI planning algorithm contains at least one of these actions. For example, in the previous example, (B or C). In order to reach the goal, a plan must include either B or C. It is arguably ambiguous whether a plan with B is preferable over a plan with C. Thus, a question that the program code can pose to a user to disambiguate is whether the plan should include B or C. This question will narrow the number of plans without having to delve further into the various steps of these plans.

Embodiments of the present invention are inextricably tied to computing and are directed to a practical application. AI planning is a branch of AI, which is inextricably tied to computing. However, the unordered top-quality planning problems that are solved by aspects of embodiments of the present invention also enable improvements to the technical computing field. As mentioned earlier, the examples herein enable a resource to discern and apply a preferred plan to an AI planning problem. Understanding which plan among those returned is a preferred plan (e.g., the best plan) increases the speed at which a processor can derive solutions to unordered top-quality planning problems, thus reducing CPU time. Additionally, these unordered top-quality planning problems (to which the preferred plan is a solution) are specific challenges in computing, including but not limited to, hypothesis exploration for malware detection in computing systems, scenario planning for enterprise risk management, state projection, and automated large-scale data analysis. Plan recognition through AI planning can detect malware because the program code (executing on one or more processors) can detect malware based on the program code deriving potentially unreliable observations from network traffic. In a healthcare setting, AI planning can assist care providers in early detection of health complications in an intensive care unit setting. There are examples of AI planning being utilized in the energy domain, including to project the price of oil and volume of oil produced into the future (e.g., fifteen years into the future). In the aforementioned risk management setting, AI planning can be utilized to assist financial organizations in identifying and managing emerging risks. Thus, aspects of the examples herein can be integrated into systems that solve various challenges that are unique to computing and given that deriving these solutions is inextricably tied to computing, aspects herein improve the functioning of the computing system processing by reducing CPU time for deriving a solution. The examples herein are directed to a practical application (and improved computing) at least because the examples herein are directed to selecting a best fit plan (e.g., a preferred plan) computing from a set of top-quality plans using disambiguation. The example herein, when integrated into certain existing solutions, can speed up the selection of preferred plans, scale better on larger problems in the future, and scale to return more effective plans from the application perspective. The examples herein can be integrated with various AI planning approaches in order to hone the results returned into more effective solutions.

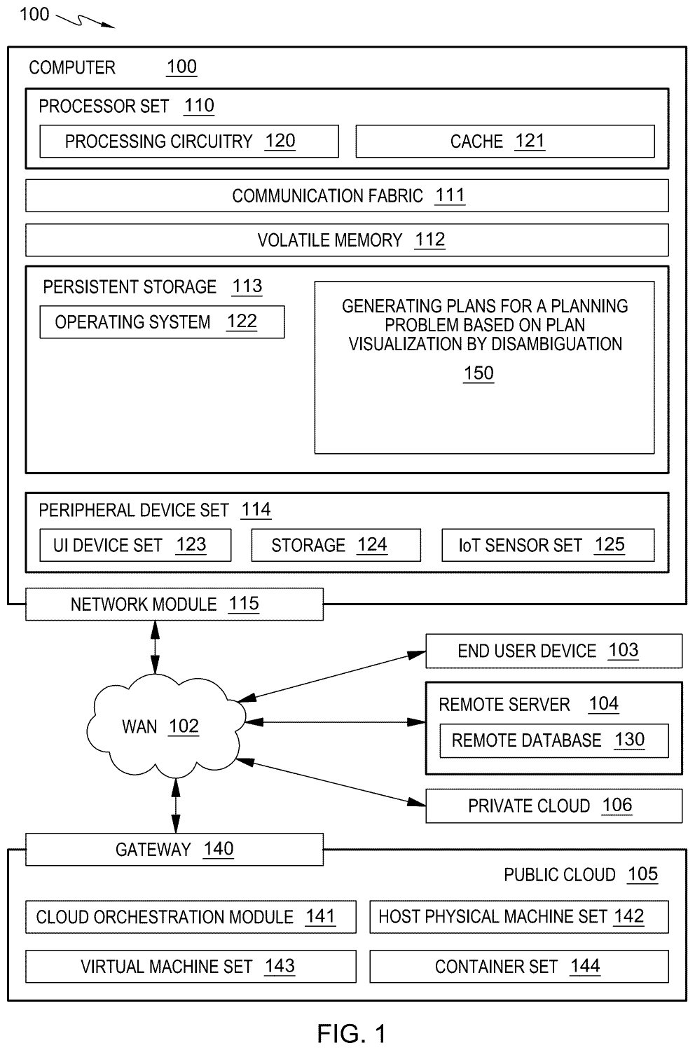

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for generating plans for a planning problem based on plan visualization by disambiguation 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

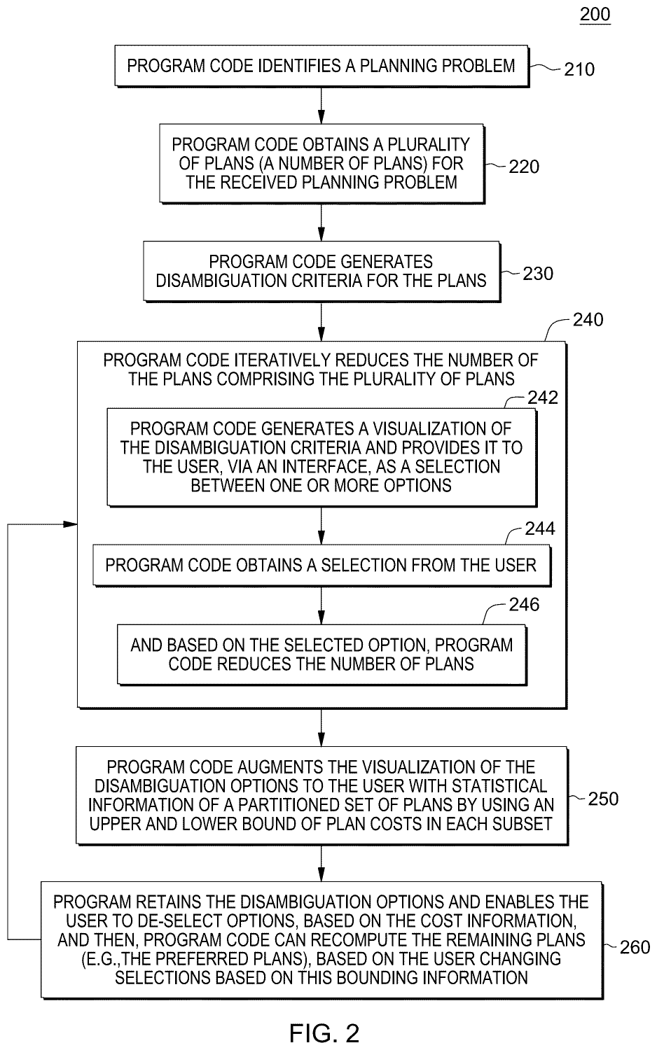

FIG. 2 is a workflow 200 that illustrates various aspects of some examples herein. As discussed above, in embodiments of the present invention, program code generates plans based on plan visualization by disambiguation. It is through the visualization by disambiguation that the program code identifies the preferred plans for utilization in addressing an AI planning problem. This workflow 200 provides an overview of various aspects which are discussed in greater detail herein. In the workflow 200, program code identifies a planning problem (210). The program code obtains a plurality of plans (a number of plans) for the received planning problem (220). The program code can obtain these plans (e.g., planning problem solutions) from a variety of external systems and/or can generate the plans based on applying one or more algorithm. For example, the plans could have been generated, in part, by utilizing a K* top quality planner. The program code generates disambiguation criteria for the plans (230). The disambiguation criteria in some examples are a collection of action landmarks. The program code can create a choice between various plans based on some plans including one landmark and others including another landmark. For example, the program code can identify a set of disjunctive action landmarks in the plurality of plans. The program code can generate questions around the content of a set of landmarks and based on a user indicating that a given landmark is preferred over another, the program code can reduce the number of plans.

In some examples herein, the program code reducing the plans is an iterative process. The program code continues to reduce the number of plans until all the remaining plans include the same selection (e.g., landmark) and therefore, the program code cannot reduce the number of plans further. Thus, as illustrated in the workflow 200, the program code iteratively reduces the number of the plans comprising the plurality of plans (240). To iteratively reduce the number of plans, the program code generates a visualization of the disambiguation criteria and provides it to the user, via an interface, as a selection between one or more choice options (242). In various examples, the program code can generate the visualization of the disambiguation questions in a variety of ways, some of which are provided herein as illustrative examples. For example, the program code can provide options to a user through a graphical user interface (GUI) through text and/or visuals. In some examples, a user can be asked to select a choice by highlighting or otherwise designating a selection in the GUI. In some examples, the program code generates a visualization of a collection of action landmarks to represent a part of the planning problem relevant to a given disambiguation step. In some examples, the visual generated by the program code enables a user to build a plan from the ground up through an iterative selection of disambiguation options. In this example, the user can narrow the plurality of plans by building forward from the initial state of the planning problem. In some examples, the visual generated by the program code enables a user to narrow the plurality of plans by building backwards from a goal achieved by the plan (e.g., the goal of the planning problem). In some examples, the program code can display, in a GUI, all relevant plans (e.g., in a graphical representation) that contain all the relevant plans from an initial plan to a goal state and the user can reduce the space comprising all the plans through by making iterative selections of disambiguation options. Thus, in these examples, regardless of the manner in which the program code visualizes the disambiguation options, when a user makes a selection, the program code obtains a selection from the user (244), and based on the selected option, the program code reduces the number of plans (246).

In some examples, the program code can provide, in the visual (e.g., 242), additional information that could influence a user's choice or plans and/or automatically narrow the plurality of plans. The program code can augment the visualization of the disambiguation options to the user with statistical information of a partitioned set of plans by using an upper and lower bound of plan costs in each subset (250). In these examples, the program code can retain the disambiguation options and enable the user to de-select options, based on the cost information, and then, the program code can recompute the remaining plans (e.g., the preferred plans), based on the user changing selections based on this bounding information (260).

In various examples herein, a user may navigate forward and/or backward to narrow a number of plans in a plurality of plans that address a given planning problem. For example, a user could decide to backtrack (e.g., make different decisions related to choices between disjunctive action landmarks) based, for example, on new and/or newly available to the user, information. The program code can enable a user to de-select choices and the program code will change the reduced set of plans based on the user backing out of earlier choices. The program code can recompute the reduced set of plans independent of the sequence of selection. Disambiguation criterion logically and efficiently reduces sets of plans, but in all circumstances, it may not capture every type of user preferences. Thus, the program code generates the interface and generates choices in a manner that enables a user to back out of choices that would not lead to preferred plans. The program code in examples herein can utilize disambiguation of set of plans to reduce a set of relevant plans to preferred plans after the program code had modeled known preferences and utilized these preferences to generate a set of plans. However, in certain cases, it can be difficult to represent all preferences efficiently for a solver. In these circumstances, the program code can re-rank plans or disambiguation options in the case there are unmodeled but known preferences. Utilizing disambiguation options reduces the number of plans more quickly than selecting between all alternative steps in a set of plans to narrow the choices of plans.

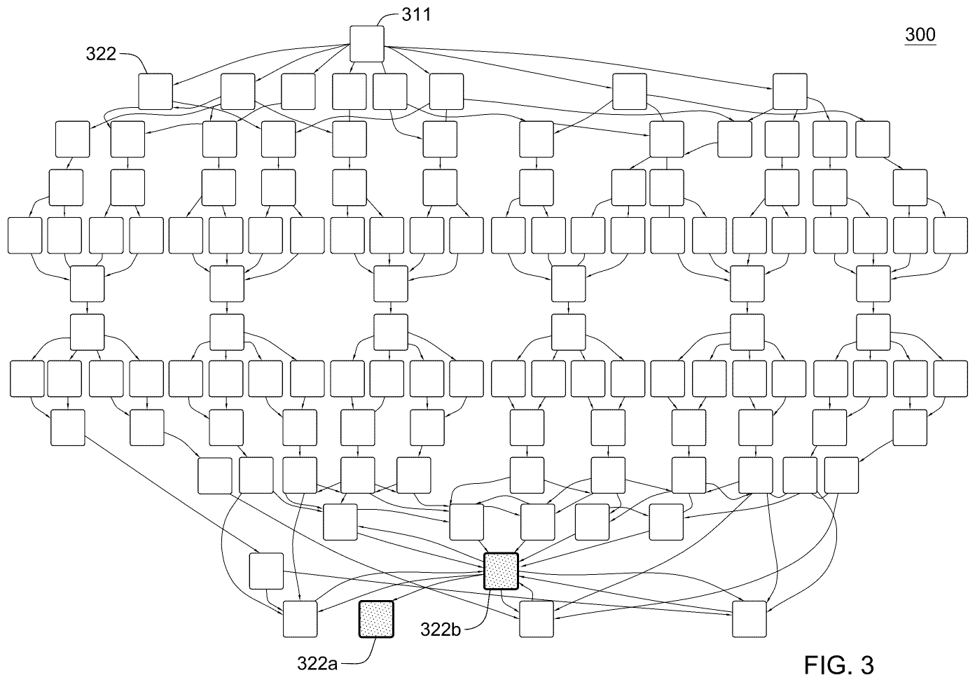

FIG. 3 is a visualization 300 of various landmarks in a set of plans. The plans originate from an initial state 311 and, in this example, the program code displays the landmarks 322 (only one is labeled to eliminate visual confusion but all objects are landmarks) in the plans until the plans reach disjunctive action landmarks 323a 323b, meaning that in the set of plans, each plan includes one of these action landmarks 323a 323b. The program code therefore provides a user, via a GUI communicatively coupled to one or more processors executing the program code, with options to select one of the action landmarks 323a 323b and based on this selection, the program code reduces the number of plans visualized. For example, if a user selects the first action landmark 323a, the program code can eliminate any plan with the second action landmark 323b. As discussed earlier, various examples enable the user to back out of these decisions and based on backing out of previously selected options, the program code generates a new visualization or revised the visualization to reflect the change. Thus, at all times, the program code can display the plans that fit the preferences expressed by the user based on the inputs of the user.

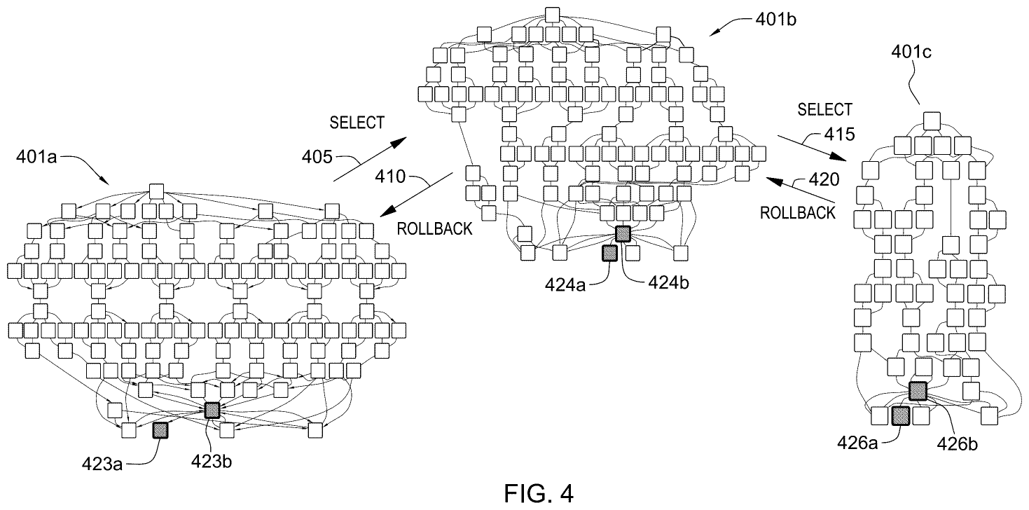

FIG. 4 illustrates various visualizations 401a 401b 401c generated by the program code. The visualizations 401a 401b 401c illustrate how the program code changes the visualization of its disambiguation as a user selects action landmarks 423a 423b 424a 424b 426a 426b (e.g., FIG. 3, disjunctive action landmarks 323a 323b). For ease of understanding, the visualizations 401a 401b 401c each include a binary choice. However, in the examples herein, when the program code automatically determines the disjunctive action landmarks, the program code can identify a set of two or more action landmarks. The number of landmarks that a user would be prompted to select between would be dependent upon the contents (e.g., tasks) of the plans. In FIG. 4, the program code generates each visualization 401a 401b 401c (e.g., graph) from the set of plans highlighting all possible paths from initial state to goal along with highlighted landmarks for selection. The user can whittle down plans iteratively using the landmarks selected by the user (via a GUI generated by the program code). When a user makes a selection, the program code changes the visualization to reflect the exclusion of plans with an un-selected action landmark. If a user changes course and de-selected an action landmark he or she previously selected, that program code will revert to the plans visualized before the user made the selection. To this end, FIG. 4 illustrates how, when a user selects actions landmarks and subsequently rolls back these decisions, the program code changes the visualization to reflect the choices. For example, when a user selects (405) an action landmark 423a 423b in the first visualizations 401a, the program code generates and displays the second visualization 401b and highlights a next set of action landmarks 424a 424b. Should the user de-select the action landmark 423a 423b the user selected, the program code will rollback (410) to the first visualizations 401a, displaying the prior choice to the user. The user can also select (415) an action landmarks 424a 424b, and the program code will generate and/or display the third visualization 401c. The plans in the third visualization 401c do not include any plans with the unselected action landmark. The program code displays a next action landmark 426a 426b choice to the user. Should the user de-select a prior selection, the program code can rollback (420) to the second visualization 401b. These visualizations are all just examples of one way that the program code can provide disambiguation to a user. There are other examples of possible displays that provide disambiguation based on providing a user with a choice of disjunctive action landmarks and narrowing the plans displayed based on a choice of one of these landmarks, by the user.

As illustrated in FIG. 2, in some examples, the program code can access additional data and provide these data to the user to enable the user to choose between disjunctive action landmarks with this additional information. Action landmarks represent portions of plans that, if removed, prevent navigation from an initial state to a goal, and a member of the set of disjunctive action landmarks is present in every plan. To enhance disambiguation, outside data can be provided to a user by the program code. For example, is a planning problem terminates at identifying and contacting a candidate for a job, the program code can obtain data related to the educational and professional skills of a given candidate by extracting these data from a resume stored in an enterprise (e.g., cloud) storage system and provide that information to the user, for example, as a final check on whether a selected candidate should be provided with a job offer.

Algorithm 1 below is an algorithm that can be executed by program code in embodiments of the present invention to provide disambiguation of plans that address an AI planning problem. Landmarks are subgoals that must be achieved in every plan. Action landmarks are actions that must be part of any plan for a given task. First achievers are actions that, if applied, will result in a state where a landmark holds. The input to the algorithm is a planning task.

Algorithm 1:
A. Find a set of plans P for the planning task
B. Find a set L of disambiguation criteria for plans
C. Create and show a graphical representation (digraph) of P
D. Repeat until |L|≥1 or user break:
1. Choose a disambiguation criteria 1={a₁, . . . , aₖ} from L
2. Find subsets P₁, . . . , Pₖ of P according to 1, such that ∪Pᵢ=P
3. Let the user choose between aᵢ in {a₁, . . . , aₖ} and set P=Pᵢ accordingly
4. Create and show a graphical representation (digraph) of P
E. Choose a plan from P to return (if |P|>1, choose randomly)

In some examples, rather than soliciting a response from a user to choose a plan, the program code can also provide the user with an option to roll back a previous selection. In this circumstance, the program code can push the disambiguation criterion 1 back to the full set of disambiguation criteria L. Otherwise, the program code can set the plan to that selected based on the action landmark.

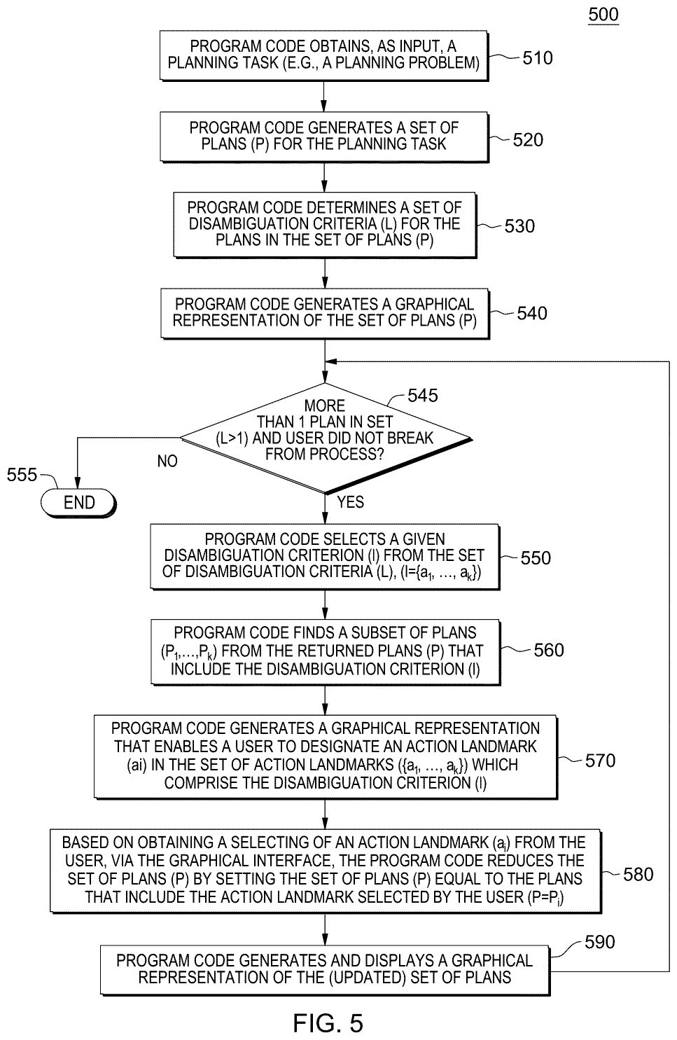

FIG. 5 illustrates various aspects of program code in embodiments herein executing Algorithm 1 as a workflow 500. The program code (executing on one or more processors) obtains, as input, a planning task (e.g., a planning problem) (510). The program code generates a set of plans (P) for the planning task (520). A plan that addressed the planning task would start at a given initial state and terminate at a goal, both of which would be defined in the planning task (problem) itself. The program code determines a set of disambiguation criteria (L) for the plans in the set of plans (P) (530). Set L of disambiguation criteria can be disjunctive action landmarks for the planning task. The program code generates a graphical representation of the set of plans (P) (540). The program code then executes an iterative process that it terminates (555) when there is only one plan (L=1) and/or if a user selects a specific plan (545). If the user has not broken with the process (e.g., selected a plan) and the number of plans in the set (L) is greater than one (545), the program code selects a given disambiguation criterion (1) from the set of disambiguation criteria (L) (550). The disambiguation criterion (1) is a set of action landmarks ({a₁, . . . , aₖ}). The program code can utilize varied approaches to select disambiguation criterion (1) from the set of criteria (L). In what can be understood as a greedy approach, in some examples, the program code can select a criterion that (locally) maximizes disambiguation, as illustrated in Equation 1 below.

$$arg {min}_{\{ l ∈ L \}} {max}_{\{ {a}_{i} ∈ l \}} \vert {P}_{i} \vert \qquad ( Equation 1 )$$

The program code can also select disambiguation criterion (1) from the set of criteria (L) using a so-called build approach. In this approach, the program code selects a criterion that is closest to goal/initial state (in digraph representing the progression of the plans). The program code can display only the part of the digraph containing the goal (or initial) state and part of the plans containing the actions chosen by the user. The program code can hide nodes and edges upstream (or down-stream) from the disambiguation criterion (1).

The program code finds a subset of plans (P₁, . . . , Pₖ) from the returned plans (P) that include the disambiguation criterion (1) (560). At a first iteration of the process, the subset of plans could include the entire set of plans P. The program code generates a graphical representation that enables a user to designate an action landmark (aᵢ) in the set of action landmarks ({a₁, . . . , aₖ}) which comprise the disambiguation criterion (1) (570). Based on obtaining a selection of an action landmark (aᵢ) from the user, via the graphical interface, the program code reduces the set of plans (P) by setting the set of plans (P) equal to the plans that include the action landmark selected by the user (P=Pᵢ) (580). The program code generates and displays a graphical representation of the (updated) set of plans (590). In various examples, the program code can generate and display different graphical representations (e.g., digraphs) for P, the set of plans that address a given planning task or planning problem. For example, the program code can display all plans that meet various criteria during the iterative processor it can display only common parts of the various relevant plans.

As illustrated in FIG. 5, this workflow 500 terminates (555) when a plan is selected (and can be automatically executed by the program code) (545) either because there is only one plan in the set (P) remaining or because the user and/or another process has selected a plan.

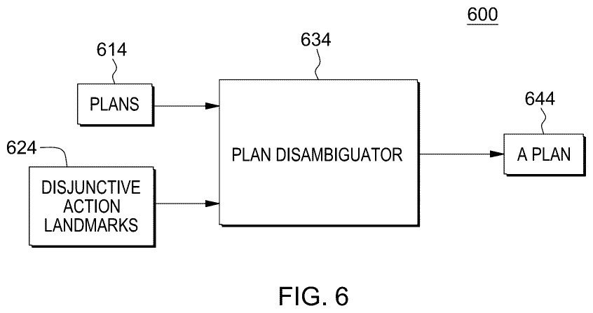

FIG. 6 is a system diagram 600 that illustrates various aspects of some examples herein. Although various aspects are represented as different modules, this view is provided for illustrative purposes only and not to suggest any limitations to how program code performing various functions is configured, combined, and/or separated. The system diagram 600 provides a non-limiting possible configuration for various aspects of some examples. As illustrated in FIG. 6, inputs to program code comprising a plan disambiguator 634 include plans 614 (generated by program code in an AI planning system) and disjunctive action landmarks 624 (generated by program code as described in various examples herein). The program code of the plan disambiguator 634 obtains the plans 614 and the disjunctive action landmarks 624 and generates a visualization (e.g., FIGS. 2-3), so that the user can select action landmarks 624 and based on those selections, the program code can reduce the set of plans until the program code of the plan disambiguator 634 can output a (preferred) plan 644.

Embodiments of the present invention include computer-implemented methods, computer program products, and computer systems that comprise program code executing on one or more processors that utilize disambiguation to identify a preferred plan from a set of plans for a planning problem. In some examples, program code executing on one or more processors identifies a planning problem, wherein the planning problem comprises an initial state and a goal state. The program code obtains the set of plans for the planning problem. The program code determines a set of disambiguation criteria for the plans comprising the set of plans. The program code iteratively reduces the plans comprising the set of plans until a termination event occurs. To iteratives reduces the plans, the program code determines that the set of plans comprises more than one plan, based on the determining. The program code selects a disambiguation criterion from the disambiguation criteria, where the disambiguation criterion comprises a set of two or more options. The program code identifies plans of the set of plans that comprise the disambiguation criterion. The program code generates and displays in a graphical user interface communicatively coupled to the one or more processors, to a user, a graphical representation of the plans of the set of plans comprising the disambiguation criterion. The graphical representative comprises a prompt to select an option of the two of more options of the disambiguation criterion set. The program code obtains a selection from the user. Based on the selection, the program code reduces the set of plans from the set of plans comprising the disambiguation criterion to the set of plans comprising the selection. A technical advantage of the described computer-implemented methods, computer program products, and computer systems is that implementing the aspects described increases the speed of generating top-quality plans and faster generation of top-quality plans is crucial for the products and services that depend on planning as their computational engines, many of which are discussed herein. The aspects described herein enable the program code to provide a “best” or preferred plan, based on various preferences and external factors. Thus, the systems of the AI planning system are improved qualitatively based on utilizing the examples herein.

Various additional examples of the computer-implemented methods, computer program products, and computer systems are described below, and these examples, including and excluding the additional examples enumerated below, in any combination (provided these combinations are not inconsistent), increase the speed of generating top-quality plans by providing a preferred or best plan quickly and reliably.

In some examples, the termination event is selected from the group consisting of: a user ending the iteratively reducing and the set of plans consisting of one plan.

In some examples, the termination event is the set of plans consisting of one plan, wherein the one plan comprises the preferred plan.

In some examples. The program code obtaining the set of plans comprises the program code generating, the set of plans.

In some examples, the set of disambiguation criteria comprise a set of disjunctive action landmarks.

In some examples, the set of two or more options comprise a set of disjunctive action landmarks.

In some examples, the program code obtains an indication that a user has de-selected the selection in the graphical user interface. The program code can increase the plans comprising the set of plans to include includes plans comprising the two of more options of the disambiguation criterion set. The program code can generate and display an updated graphical representative of the set of plans.

In some examples, the program code displaying includes: The program code prompting the user to select an option from the two of more options of the disambiguation criterion set.

In some examples, the program code obtains a new selection. Based on the new selection, the program code can reduce the plans comprising the set of plans to plans comprising the selection.

In some examples, the graphical representative of the plans of the set of plans comprising the disambiguation criterion comprises a visualization of a part of the planning, where the part of the planning problem is relevant to the disambiguation criterion. A user can utilize the graphical representation to build forward from the initial state of the planning problem.

In some examples, the graphical representative of the plans of the set of plans comprising the disambiguation criterion comprises a visualization of a part of the planning, where the part of the planning problem is relevant to the disambiguation criterion. A user can utilize the graphical representation to build backward from the goal state of the planning problem.

In some examples, the graphical representative of the plans of the set of plans comprising the disambiguation criterion comprises a graph comprising the set of plans depicted starting at the initial state and terminating at the goal state and the program code iteratively reducing reduces a space comprising the set of plans.

In some examples, the termination event comprises the program code augmenting the graphical representative of the plans of the set of plans with statistical information of a partitioned set of plans based on upper bounds and lower bounds of plan costs. The program code can reduce the plans comprising the set of plans based on the statistical information. The program code can re-commence the iteratively reducing with the reduced plains comprising the set of plans.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for utilizing disambiguation to identify a preferred plan from a set of plans for a planning problem comprising:
identifying, by one or more processors, a planning problem, wherein the planning problem comprises an initial state and a goal state;
obtaining, by the one or more processors, plans comprising the set of plans for the planning problem;
determining, by the one or more processors, a set of disambiguation criteria for the plans comprising the set of plans;
iteratively reducing, by the one or more processors, the plans comprising the set of plans until a termination event occurs, the iteratively reducing comprising:
determining, by the one or more processors that the set of plans comprises more than one plan;
based on the determining, selecting, by the one or more processors, a disambiguation criterion from the disambiguation criteria, wherein the disambiguation criterion comprises a set of two or more options;
identifying, by the one or more processors, plans of the set of plans that comprise the disambiguation criterion;
generating and displaying, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set;
obtaining, by the one or more processors, a selection from the user; and
based on the selection, reducing, by the one or more processors, the set of plans from the set of plans comprising the disambiguation criterion to the set of plans comprising the selection.

2. The method of claim 1, wherein the termination event is selected from the group consisting of: a user ending the iteratively reducing and the set of plans consisting of one plan.

3. The method of claim 2, wherein the termination event is the set of plans consisting of one plan, wherein the one plan comprises the preferred plan.

4. The method of claim 1, wherein obtaining the set of plans comprises:
generating, by the one or more processors, the set of plans.

5. The method of claim 1, wherein the set of disambiguation criteria comprise a set of disjunctive action landmarks.

6. The method of claim 1, wherein the set of two or more options comprise a set of disjunctive action landmarks.

7. The method of claim 1, further comprising:
obtaining, by the one or more processors, an indication that a user has de-selected the selection in the graphical user interface;
increasing, by the one or more processors, the plans comprising the set of plans to include includes plans comprising the two of more options of the disambiguation criterion set; and
generating and displaying, by the one or more processors, an updated graphical representative of the set of plans.

8. The method of claim 7, wherein the displaying comprises:
prompting, by the one or more processors, the user to select an option from the two of more options of the disambiguation criterion set.

9. The method of claim 8, further comprising:
obtaining, by the one or more processors, a new selection; and
based on the new selection, reducing, by the one or more processors, the plans comprising the set of plans to plans comprising the selection.

10. The method of claim 1, wherein the graphical representative of the plans of the set of plans comprising the disambiguation criterion comprises a visualization of a part of the planning, wherein the part of the planning problem is relevant to the disambiguation criterion, wherein a user can utilize the graphical representation to build forward from the initial state of the planning problem.

11. The method of claim 1, wherein the graphical representative of the plans of the set of plans comprising the disambiguation criterion comprises a visualization of a part of the planning, wherein the part of the planning problem is relevant to the disambiguation criterion, wherein a user can utilize the graphical representation to build backward from the goal state of the planning problem.

12. The method of claim 1, wherein the graphical representative of the plans of the set of plans comprising the disambiguation criterion comprises a graph comprising the set of plans depicted starting at the initial state and terminating at the goal state, wherein the iteratively reducing reduces a space comprising the set of plans.

13. The method of claim 1, wherein the termination event comprises augmenting the graphical representative of the plans of the set of plans with statistical information of a partitioned set of plans based on upper bounds and lower bounds of plan costs;
reducing, by the one or more processors, the plans comprising the set of plans based on the statistical information; and
re-commencing, by the one or more processors, the iteratively reducing with the reduced plains comprising the set of plans.

14. A computer system comprising:
a memory; and
one or more processors in communication with the memory, wherein the computer system is configured to perform a method, said method comprising:
identifying, by the one or more processors, a planning problem, wherein the planning problem comprises an initial state and a goal state;
obtaining, by the one or more processors, plans comprising the set of plans for the planning problem;
determining, by the one or more processors, a set of disambiguation criteria for the plans comprising the set of plans;
iteratively reducing, by the one or more processors, the plans comprising the set of plans until a termination event occurs, the iteratively reducing comprising:
determining, by the one or more processors that the set of plans comprises more than one plan;
based on the determining, selecting, by the one or more processors, a disambiguation criterion from the disambiguation criteria, wherein the disambiguation criterion comprises a set of two or more options;
determining, by the one or more processors, which plans on the set of plans comprise the disambiguation criterion;
generating and displaying, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set;
obtaining, by the one or more processors, a selection from the user; and
based on the selection, reducing, by the one or more processors, the set of plans from the set of plans comprising the disambiguation criterion to the set of plans comprising the selection.

15. The computer system of claim 14, wherein the termination event is selected from the group consisting of: a user ending the iteratively reducing and the set of plans consisting of one plan.

16. The computer system of claim 15, wherein the termination event is the set of plans consisting of one plan, wherein the one plan comprises the preferred plan.

17. The computer system of claim 14, wherein obtaining the set of plans comprises:
generating, by the one or more processors, the set of plans.

18. The computer system of claim 14, wherein the set of disambiguation criteria comprise a set of disjunctive action landmarks.

19. The computer system of claim 14, wherein the set of two or more options comprise a set of disjunctive action landmarks.

20. A computer program product for utilizing disambiguation to identify a preferred plan from a set of plans for a planning problem comprising:
a computer readable storage media having program instruction embodied therewith, the program instructions executable by a processing circuit, to cause the processing circuit to:
identify, by the one or more processors, a planning problem, wherein the planning problem comprises an initial state and a goal state;
obtain, by the one or more processors, plans comprising the set of plans for the planning problem;
determine, by the one or more processors, a set of disambiguation criteria for the plans comprising the set of plans;
iteratively reduce, by the one or more processors, the plans comprising the set of plans until a termination event occurs, the iteratively reducing comprising:
determine, by the one or more processors that the set of plans comprises more than one plan;
based on the determining, select, by the one or more processors, a disambiguation criterion from the disambiguation criteria, wherein the disambiguation criterion comprises a set of two or more options;
determine, by the one or more processors, which plans on the set of plans comprise the disambiguation criterion;
generate and display, by the one or more processors, in a graphical user interface communicatively coupled to the one or more processors, to a user, a graphical representation of the plans of the set of plans comprising the disambiguation criterion, wherein the graphical representative comprises a prompt to select an option of the two of more options of the disambiguation criterion set;
obtain, by the one or more processors, a selection from the user; and
based on the selection, reduce, by the one or more processors, the set of plans from the set of plans comprising the disambiguation criterion to the set of plans comprising the selection.
